(19) United States
(12) Patent Application Publication
(10) Pub. No.: US 2008/0031386 A1
(43) Pub. Date: Feb. 7, 2008

(54) Method and device for robust signal detection in wireless communications

(75) Inventors: Shang-Ho Tsai, Kaohsiung (TW); Chung-Yen Huang, Tao-Feng Town (TW); Shih-Chung Yin, Hsinchu City (TW)

Correspondence Address: THE LAW OFFICES OF ANDREW D. FORTNEY, PH.D., P.C., 401 W FALLBROOK AVE STE 204, FRESNO, CA, 93711-5835, US

(73) Assignee: MediaTek Inc.

(21) Appl. No.: 11/498,432

(22) Filed: Aug. 2, 2006

(51) Int. Cl. H04L 27/06

(52) U.S. Cl. 375/340

(57) ABSTRACT

A method, algorithm, architecture, circuits, and/or systems for robust radar signal detection for wireless communications are disclosed. In one embodiment, a method of detecting a predefined signal pulse event in a wireless network device can include the steps of: (i) comparing a power of a received signal pulse to a predetermined power threshold of a predefined signal; (ii) determining a duration of the received signal pulse when the power of the received signal pulse is greater than the predetermined power threshold; and (iii) indicating an occurrence of the predetermined signal pulse event when the duration of the received signal pulse is between first and second predetermined duration thresholds of the predefined signal. The predefined signal pulse event can be a radar signal pulse, for example. Embodiments of the present invention can advantageously provide a reliable and simplified approach for radar signal detection suitable for wireless network devices.

### FIELD OF THE INVENTION

The present invention generally relates to the field of wireless communications circuits. More specifically, embodiments of the present invention pertain to methods, algorithms, architectures, circuits, and/or systems for robust radar signal detection for wireless communications.

### DISCUSSION OF THE BACKGROUND

Many wireless communications (e.g., wireless local area networks (WLANs)) make use of unlicensed bands in the 5 MHz frequency range. However, signals other than network traffic may be present in the same channels, such as radar signals. In order to prevent network traffic interference with radar signals and mitigate possible safety concerns, the Federal Communications Commission (FCC) has regulated that WLAN devices be able to detect radar signals and then switch the wireless network device to another channel to avoid such interference.

Referring now to FIG. 1, a waveform diagram showing a conventional radar signal including a plurality of signal pulses is indicated by the general reference character 100. The radar signal 100 can include a series of pulses that can be transmitted in a series of bursts (e.g., bursts 102 and 106). Burst 102 can include pulses 104-0, 104-1, and 104-2, and burst 106 can include pulses 108-0, 108-1, and 108-2, for example. Bursts 102 and 106 may also be separated by a gap, as shown.

Each radar signal pulse may be a high-frequency (e.g., about 5 GHz) sine wave, and may have a pulse duration (W) of approximately 1 μsec-5 μsec. The pulse period is the time between the start of consecutive pulses and is the inverse of the pulse repetition frequency (PRF). The pulse period is typically on the order of about 1 msec. The burst length (L) refers to the number of pulses in a burst or the time duration associated with the burst of pulses. The burst interval (P) is the time from the start of one burst (e.g., 102) to the start of the next consecutive burst (e.g., 106), and is typically on the order of 1 sec-10 sec.

The European Telecommunications Standards Institute (ETSI) has proposed several guidelines for radar detection in certain applications. One such guideline or method is to detect whether there is any received signal power above −62 dBm within a defined period or signal burst length. Thus, the power level of −62 dBm is the minimum radar power level required to be detected. However, a drawback of this approach is its possible high rate of false alarms (e.g., erroneous positive detection of radar).

Another conventional method for radar signal detection is to periodically suspend network traffic and then check whether there is any received signal power exceeding −62 dBm during this suspension time. However, a drawback of this approach is that it may possibly deteriorate network performance and/or its overhead requirement (e.g., reduction of network bandwidth for activities other than network transmissions).

Another conventional method for radar signal detection (see, e.g., U.S. Pat. No. 6,697,013) may require a determination of whether events correspond to network traffic (e.g., typical packet type communications with the network device), but this approach requires the aid of a base band processor for determining whether the received signal is a packet or not, thus increasing the overall system complexity. What is needed is a reliable and simplified approach for radar signal detection suitable for wireless communication applications.

### SUMMARY OF THE INVENTION

Embodiments of the present invention pertain to methods, algorithms, architectures, circuits, and/or systems for robust signal detection for wireless communications.

In one embodiment, a method of detecting a predefined signal pulse event in a wireless network device can include the steps of: (i) comparing a power of a received signal pulse to a predetermined power threshold of a predefined signal; (ii) determining a duration of the received signal pulse when the power of the received signal pulse is greater than the predetermined power threshold; and (iii) indicating an occurrence of the predetermined signal pulse event when the duration of the received signal pulse is between first and second predetermined duration thresholds of the predefined signal. The predefined signal pulse event can be a radar signal pulse, for example.

In another embodiment, a method of detecting a predefined signal in a wireless network device can include the steps of: (i) inserting a first logic level into an entry in an event table with a plurality of entries when an occurrence of a predefined signal pulse event is detected, or inserting a second logic level into the entry when the occurrence of the predefined signal pulse event is not detected; and (ii) repeating the inserting step for a next one of the plurality of entries. Further, the inserting step can be repeated until a logic level is entered a plurality of times in each of a plurality of columns. Then, a presence of the predefined signal can be indicated when a number of entries containing the first logic level in at least one column is greater than a threshold. The predefined signal can be a radar signal and the threshold can be a radar signal pulse number, for example.

In another embodiment, a method of detecting a predefined signal in a wireless network device can include the steps of: (i) changing a value of an entry in an event table with a plurality of entries when a predefined signal pulse event has been detected; (ii) repeating the changing step for a next one of the plurality of entries; and (iii) indicating that the predefined signal has been detected when one of the entry values reaches a threshold value. The predefined signal can be a radar signal and the threshold value can be zero, for example.

In another embodiment, a physical layer device can include: (i) an event table with a plurality of entries arranged in a plurality of columns; (ii) a control circuit configured to modify one of the plurality of entries when a predefined signal pulse event is detected; and (iii) an indicator circuit configured to provide a predefined signal detection indication when one or a combination of the plurality of columns includes a predetermined value. The event table can also include a plurality of columns and the predefined signal can be a radar signal, for example.

Embodiments of the present invention can advantageously provide a reliable and simplified approach for radar signal detection suitable for wireless network devices. Further, embodiments of the present invention can advantageously provide for radar signal detection without the aid of a base band processor for determining whether the received signal is a packet. These and other advantages of the present invention will become readily apparent from the detailed description of preferred embodiments below.

### BRIEF DESCRIPTION OF THE DRAWINGS

FIG. 1 is a waveform diagram showing a conventional radar signal including a plurality of signal pulses.

FIG. 2 is an exemplary waveform diagram showing pulse characteristics for predefined signal pulse event detection in accordance with embodiments of the present invention.

FIG. 3 is a flow diagram showing an exemplary method of detecting a predefined signal pulse event in accordance with embodiments of the present invention.

FIG. 4 is an exemplary event table suitable for use in accordance with embodiments of the present invention.

FIG. 5 shows the event table of FIG. 4 adapted for an exemplary procedure of detecting a predefined signal in accordance with embodiments of the present invention.

FIG. 6 is a flow diagram showing an exemplary method of detecting a predefined signal, using an event table as shown in FIGS. 4 and 5, in accordance with embodiments of the present invention.

FIG. 7 is another exemplary event table showing an exemplary procedure of detecting a predefined signal in accordance with embodiments of the present invention.

FIG. 8 is a flow diagram showing an exemplary method of detecting a predefined signal, using an event table as shown in FIG. 7, in accordance with embodiments of the present invention.

FIG. 9 is a block diagram showing an exemplary system for detecting predefined signals using event tables in accordance with embodiments of the present invention.

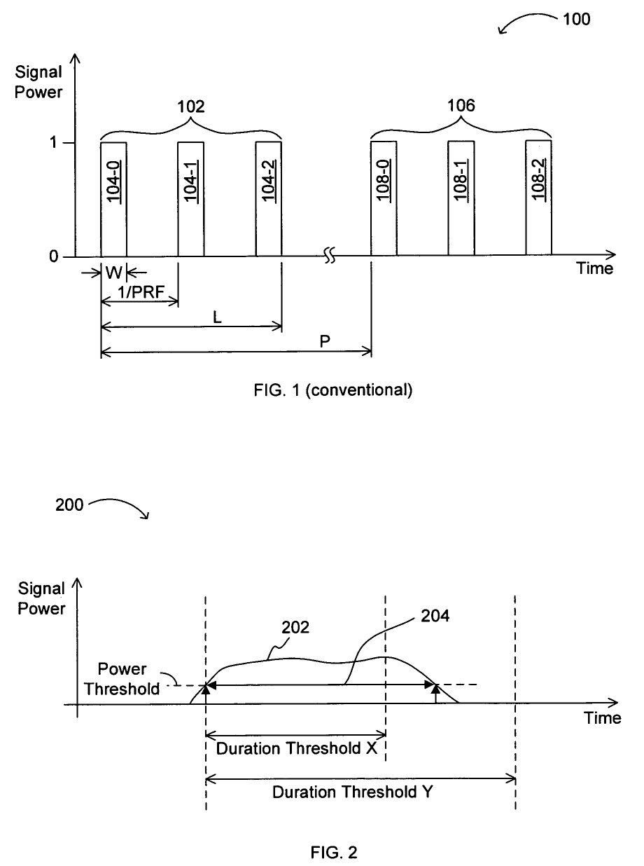

### DETAILED DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set forth in order to provide a thorough understanding of the present invention. However, it will be readily apparent to one skilled in the art that the present invention may be practiced without these specific details. In other instances, well-known methods, procedures, components, and circuits have not been described in detail so as not to unnecessarily obscure aspects of the present invention.

Some portions of the detailed descriptions which follow are presented in terms of processes, procedures, logic blocks, functional blocks, processing, and other symbolic representations of operations on code, data bits, data streams or waveforms within a computer, processor, controller and/or memory. These descriptions and representations are generally used by those skilled in the data processing arts to effectively convey the substance of their work to others skilled in the art. A process, procedure, logic block, function, process, etc., is herein, and is generally, considered to be a self-consistent sequence of steps or instructions leading to a desired and/or expected result. The steps generally include physical manipulations of physical quantities. Usually, though not necessarily, these quantities take the form of electrical, magnetic, optical, or quantum signals capable of being stored, transferred, combined, compared, and otherwise manipulated in a computer or data processing system. It has proven convenient at times, principally for reasons of common usage, to refer to these signals as bits, waves, waveforms, streams, values, elements, symbols, characters, terms, numbers, or the like, and to their representations in computer programs or software as code (which may be object code, source code or binary code).

It should be borne in mind, however, that all of these and similar terms are associated with the appropriate physical quantities and/or signals, and are merely convenient labels applied to these quantities and/or signals. Unless specifically stated otherwise and/or as is apparent from the following discussions, it is appreciated that throughout the present application, discussions utilizing terms such as “processing,” “operating,” “computing,” “calculating,” “determining,” “manipulating,” “transforming” or the like, refer to the action and processes of a computer or data processing system, or similar processing device (e.g., an electrical, optical, or quantum computing or processing device or circuit), that manipulates and transforms data represented as physical (e.g., electronic) quantities. The terms refer to actions and processes of the processing devices that manipulate or transform physical quantities within the component(s) of a circuit, system or architecture (e.g., registers, memories, other such information storage, transmission or display devices, etc.) into other data similarly represented as physical quantities within other components of the same or a different system or architecture.

Furthermore, in the context of this application, the terms “wire,” “wiring,” “line,” “signal,” “conductor” and “bus” refer to any known structure, construction, arrangement, technique, method and/or process for physically transferring a signal from one point in a circuit to another. Also, unless indicated otherwise from the context of its use herein, the terms “known,” “fixed,” “given,” “certain,” “predefined” and “predetermined” generally refer to a value, quantity, parameter, constraint, condition, state, process, procedure, method, practice, or combination thereof that is, in theory, variable, but is typically set in advance and is generally not varied thereafter when in use.

Similarly, for convenience and simplicity, the terms “clock,” “time,” “timing,” “rate,” “period” and “frequency” are, in general, interchangeable and may be used interchangeably herein, but are generally given their art-recognized meanings. Also, for convenience and simplicity, the terms “data,” “data stream,” “waveform” and “information” may be used interchangeably, as may (a) the terms “flip-flop,” “latch” and “register,” and (b) the terms “connected to,” “coupled with,” “coupled to,” and “in communication with,” (which may refer to direct or indirect connections, couplings, or communications) but these terms are generally given their art-recognized meanings herein.

Embodiments of the present invention pertain to methods, algorithms, architectures, circuits, and/or systems for robust signal detection for wireless communications. For example, a method of detecting a predefined signal pulse event in a wireless network device can include the steps of: (i) comparing a power of a received signal pulse to a predetermined power threshold of a predefined signal; (ii) determining a duration of the received signal pulse when the power of the received signal pulse is greater than the predetermined power threshold; and (iii) indicating an occurrence of the predetermined signal pulse event when the duration of the received signal pulse is between first and second predetermined duration thresholds of the predefined signal. The predefined signal pulse event can be a radar signal pulse, for example.

In another aspect of the invention, a method and/or algorithm of detecting a predefined signal in a wireless network device can include the steps of: (i) inserting a first logic level into an entry in an event table with a plurality of entries when an occurrence of a predefined signal pulse event is detected, or inserting a second logic level into the entry when the occurrence of the predefined signal pulse event is not detected; and (ii) repeating the inserting step for a next one of the plurality of entries. Further, the inserting step can be repeated until a logic level is entered a plurality of times in each of a plurality of columns. Then, a presence of the predefined signal can be indicated when a number of entries containing the first logic level in at least one column is greater than a threshold. The predefined signal can be a radar signal and the threshold can be a radar signal pulse number, for example.

In another aspect of the invention, a method and/or algorithm of detecting a predefined signal in a wireless network device can include the steps of: (i) changing a value of an entry in an event table with a plurality of entries when a predefined signal pulse event has been detected; (ii) repeating the changing step for a next one of the plurality of entries; and (iii) indicating that the predefined signal has been detected when one of the entry values reaches a threshold value. The predefined signal can be a radar signal and the threshold value can be zero, for example.

In another aspect of the invention, a physical layer device can include: (i) an event table with a plurality of entries arranged in a plurality of columns; (ii) a control circuit configured to modify one of the plurality of entries when a predefined signal pulse event is detected; and (iii) an indicator circuit configured to provide a predefined signal detection indication when one or a combination of the plurality of columns includes a predetermined value. The event table can also include a plurality of columns and the predefined signal can be a radar signal, for example.

The invention further relates to hardware implementations of the present architecture, method and circuit. Embodiments of the present invention can advantageously provide a reliable and simplified approach for radar signal detection suitable for wireless network devices. Further, embodiments of the present invention can advantageously provide for radar signal detection without the aid of a base band processor for determining whether the received signal is a packet. The invention, in its various aspects, will be explained in greater detail below with regard to exemplary embodiments.

According to various embodiments of the present invention, a mechanism or circuit for detecting radar signals may not require elimination of non-radar events corresponding to network traffic and/or additive noise. As a result, there may be no need for the aid of a base band processor for determining whether the received signal is a packet. Such radar detection independent of base band processing can make the network device and/or system more flexible. Thus, a detection scheme in accordance with embodiments of the present invention can be incorporated into any application that requires radar or other predefined signal detection, while the base band of this application may not need to provide traffic status to the detection mechanism. For example, radar detection processing can occur in a physical layer device and may not need to be off-loaded to another device for such base band processing.

In general, a robust radar detection scheme can achieve a high detection rate, while keeping the false alarm rate low. Several channel factors, such as a multipath environment, appreciably high network traffic, and/or noise (such as additive white Gaussian noise [AWGN]), can affect the detection performance. A multipath environment may affect the received radar pulse width and amplitude. In addition, the network traffic and/or a noisy channel may lead to higher false alarm rates by making the radar signal more difficult to detect when the radar signal power is significantly less than that of the network traffic and/or noise. As will be discussed in more detail below, thresholds can be determined to accommodate signals subjected to such effects.

An Exemplary Method of Detecting a Predefined Signal Pulse Event

An exemplary method of detecting a predefined signal pulse event in a wireless network device can include the steps of: (i) comparing a power of a received signal pulse to a predetermined power threshold of a predefined signal; (ii) determining a duration of the received signal pulse when the power of the received signal pulse is greater than the predetermined power threshold; and (iii) indicating an occurrence of the predetermined signal pulse event when the duration of the received signal pulse is between first and second predetermined duration thresholds of the predefined signal. The predefined signal pulse event can be a radar signal pulse, for example.

Referring now to FIG. 2, an exemplary waveform diagram showing pulse characteristics for predefined signal pulse event detection in accordance with embodiments of the present invention is indicated by the general reference character 200. Waveform 202, representing the power of a received or detected signal, can surpass the power threshold for a duration indicated by 204. The values for duration thresholds X and Y and the power threshold can be predetermined based on the characteristics of the signal(s) to be detected. As such, duration threshold X represents the minimum expected pulse duration and duration threshold Y represents the maximum expected pulse duration. Such duration thresholds can be theoretically determined and/or empirically determined based on the actual operating environment.

As discussed above, a radar signal pulse duration can be about 1 μsec, or from about 1 μsec-5 μsec, for example. However, after passing through a multipath channel environment, the received signal may have a pulse duration greater than 1 μsec. Accordingly, the two duration thresholds can be determined according to the known or expected duration of a transmitted pulse. The duration threshold X may be set slightly less than the expected pulse duration of a radar signal, for example 1 μsec. The duration threshold Y may be set equal to the maximum expected pulse duration of a radar signal propagating through a multipath environment, for example, 1.5 μsec. In one embodiment, duration threshold Y may be selected such that adverse multipath effects are reduced or minimized. The power threshold can be related to the minimum radar power level required to be detected, such as −62 dBm. In accordance with embodiments of the present invention, the predetermined power threshold can be set slightly higher than −62 dBm in order to reduce the rate of false positive detections.

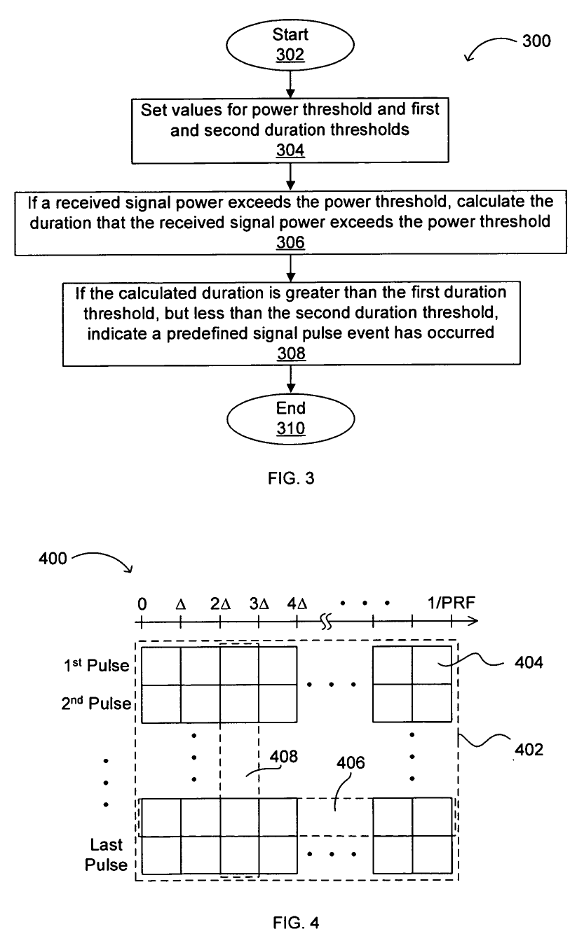

Referring now to FIG. 3, a flow diagram showing an exemplary method of detecting a predefined signal pulse event in accordance with embodiments of the present invention is indicated by the general reference character 300. The flow can begin (302) and values for the duration thresholds (e.g., duration thresholds X and Y of FIG. 2) and the power threshold can be set (304). Next, if a received signal power exceeds the power threshold, the duration that the received signal power exceeds this power threshold can be calculated (306). In the particular example of FIG. 2, this would correspond to a calculation of duration 204 as the time that waveform 202 exceeds the power threshold. In one example, the duration 204 may be calculated by recording the time at which the received signal power exceeds the power threshold, recording the time at which the received power signal falls below the power threshold, and subtracting the two values. In another example, the duration may be calculated by starting a timer or counter when the received signal power exceeds the power threshold, and stopping the timer or counter when the received signal power falls below the power threshold. In a third example, a signal on the channel being monitored is sampled periodically (e.g., at least 3 and preferably at least 4 times each duration threshold Y), and a particular digital (binary) value is assigned to the sample depending on whether the received signal power exceeds the power threshold or not.

Next in FIG. 3, if the calculated duration is greater than one duration threshold (e.g., duration threshold X), but less than another duration threshold (e.g., duration threshold Y), an occurrence of a radar signal pulse can be indicated (308) and the flow can complete (310). In the example of FIG. 2, waveform 202 is shown as greater than the power threshold for a duration 204. Further, duration 204 is greater than predetermined duration threshold X, but less than predetermined duration threshold Y. As a result, a predefined signal pulse event (e.g., a radar signal pulse) can be detected in accordance with embodiments of the present invention. In this fashion, predetermined duration and power thresholds can be used to detect a radar signal pulse event.

Referring now to FIG. 4, an exemplary event table suitable for use in accordance with embodiments of the present invention is indicated by the general reference character 400. Event table 402 can include a plurality of entries 404 arranged in rows (e.g., row 406) and columns (e.g., column 408). The number of rows of an event table can be substantially equivalent or related to the number of pulses within a burst length of the predefined signal to be detected. For example, the number of pulses in a certain predefined radar signals can be 5, 10, 18, 26, 100, 165, 300, or 500. The number of columns in an event table can relate to an empirically determined event resolution (Δ) and the pulse repetition frequency (PRF) and pulse width (W) of the predefined signal to be detected. For example, the PRF of a radar signal may be 330, 700, 1800, or 3000 Hz, and the corresponding pulse periods or 1/PRF values may be approximately 3 msec, 1.43 msec, 555.6 μsec, and 333.3 μsec, respectively. In one example, a radar signal may have a pulse period of approximately 3 msec and a pulse width of approximately 3 μsec. The event resolution may be chosen to be equal to the pulse width, 3 μsec. As such the required number of columns may be calculated by dividing the pulse period 3 msec by the event resolution 3 μsec. This operation would yield a result of 1000 columns. In this example, the event resolution is approximately equal to the pulse width of the radar signal. However, in another example, the event resolution may be chosen to be greater than or equal to the pulse width.

Because different predefined signals (e.g., different radar signals) may have different burst lengths and/or PRFs, where such signals are to be detected, an event table corresponding to each such signal can be included. For example, FCC regulations include three different radar signals for detection by wireless network devices. Accordingly, three event tables may be used to accommodate the signals to be detected according to such FCC regulations using a device in accordance with embodiments of the present invention.

A First Exemplary Method of Detecting a Predefined Signal

An exemplary method and/or algorithm of detecting a predefined signal in a wireless network device can include the steps of: (i) inserting a first logic level into an entry in an event table with a plurality of entries when an occurrence of a predefined signal pulse event is detected, or inserting a second logic level into the entry when the occurrence of the predefined signal pulse event is not detected; and (ii) repeating the inserting step for a next one of the plurality of entries. Further, the inserting step can be repeated until a logic level is entered a plurality of times in each of a plurality of columns. Then, a presence of the predefined signal can be indicated when a number of entries containing the first logic level in at least one column is greater than a threshold. The predefined signal can be a radar signal and the threshold can be a radar signal pulse number, for example.

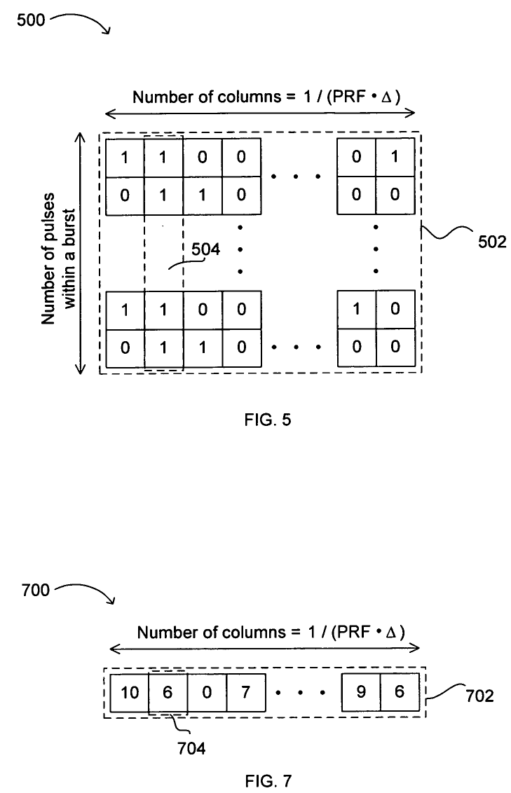

Referring now to FIG. 5, the event table of FIG. 4 adapted for an exemplary procedure of detecting a predefined signal in accordance with embodiments of the present invention is shown and indicated by the general reference character 500. A predefined signal (e.g., radar signal) detection scheme in accordance with embodiments of the invention can include the step of periodically determining whether there is a radar signal pulse event for each event resolution (Δ) time or sampling window. Detecting a predefined (e.g., radar) signal pulse event can be performed substantially as described above with reference to FIGS. 2 and 3, for example.

In FIG. 5, if a radar signal pulse event is detected (i.e., regardless of whether the positive detection is a true positive detection or a false positive detection), a logic level “1” can be inserted in event table 502 for a current time slot. Such a time slot can correspond to a sampling window, which can also correspond to a particular entry in table 502. On the other hand, if a radar signal pulse event is not detected in a given sampling window, a logic level “0” can be inserted in the corresponding entry in event table 502. Whenever an entire row, or some number of columns within a given row, is filled up with such logic levels, the first entry of the next row, corresponding to another sampling window or time slot, can be accessed. For example, the event resolution of FIG. 5 may be chosen to be equal to the pulse width of the predefined signal. A radar signal pulse event is detected in each entry corresponding to the second column. In some instances, additional radar signal pulse events may also be detected in other columns (e.g., resulting from multipath environments or channel noise).

Once either the whole table or some predetermined number of rows, columns, and/or entries is filled up, a determination can be made as to whether a valid radar signal is present. For example, if the number of logic level “1” values in any column exceeds a pulse number threshold, a radar signal may be considered detected. In the particular example of FIG. 5, each entry in column 504 is shown to contain a logic level “1” such that a radar signal detection indication can be made.

Alternatively, some combination of columns can be considered for the radar signal detection indication. For example, if a number of logic level “1” values in two adjacent columns exceeds a pulse number threshold, a radar signal detection can be made. Further, three, four, or more adjacent columns can be so combined for a radar signal detection consideration, particularly in relatively large tables. Such alternatives can be employed in a design trade-off involving detection accuracy and the prevention of false signal detections, for example. Such false signal detections may result from a multipath environment, significant network traffic, or channel noise, for example.

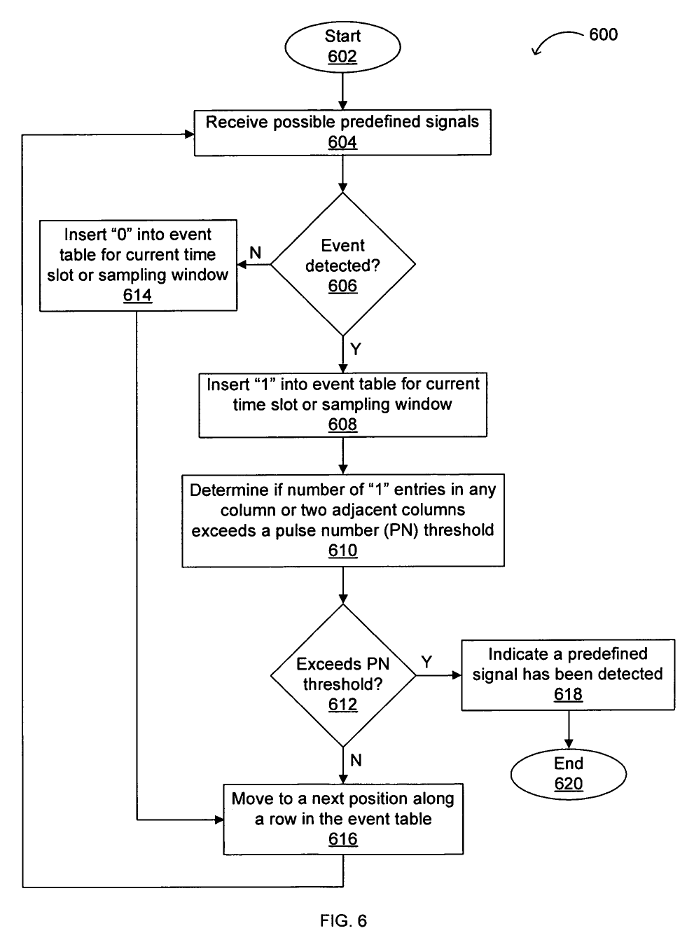

Referring now to FIG. 6, a flow diagram showing an exemplary method of detecting a predefined signal, using an event table as shown in FIGS. 4 and 5, in accordance with embodiments of the present invention is indicated by the general reference character 600. The flow can begin (602) and possible predefined signals (e.g., radar signals or other such signals with predictable characteristics) can be received (604). If an event is detected (606), a logic level “1” can be inserted into an event table for the current time slot or sampling window (608). Detecting a predefined or radar signal pulse event can be performed as described above with reference to FIGS. 2 and 3, for example.

However, if no event is detected (606) for the given time slot or sampling window, a logic level “0” can be inserted into the corresponding entry in the event table (614). Either after: (i) each logic level “1” is inserted when an event is detected; (ii) a designated number of entries have been accessed; or (iii) a sufficient number of sampling windows has passed, it can be determined if a number of “1” entries in any column or combination of columns (e.g., two adjacent columns) exceeds a pulse number threshold (610). If such a pulse number threshold has been exceeded (612), an indication can be made that a predefined signal has been detected (618) and the flow can complete (620).

On the other hand, if the pulse number threshold has not been exceeded (612) after checking the number of “1” entries in any column or combination of columns, a next position along a row in the event table can be accessed (616). This next position can also be accessed after a logic level “0” is inserted (614) when no event is detected for a given time slot, as discussed above. Once a position is changed to a next position in the event table, the flow can return to receive possible predefined signals (604).

The next position can be from left to right along a row of an event table until an entire row has been filled or accessed, then the next position can be the leftmost position in the next row down. This flow to a next position in an event table can either continue seamlessly or a reset/initialization sequence can occur once the event table has been completely filled, or a predefined signal has been detected. Such a reset or initialization state of each entry in the event table can either be the logic level “0” or some third value (e.g., other than a logic level “0” or “1”), for example.

As discussed above, a different event table can be used for each predefined (e.g., radar) signal to be detected in accordance with embodiments of the present invention. Whenever all, or a subset of, the event tables designated for given radar signals are filled up or a sufficient number of entries in each table have been accessed, a check can be performed for each column or appropriate combination of columns for each table. Further, while FCC regulations do not require a report as to the specific types of radar signals detected, the detection scheme in accordance with embodiments of the present invention can also be used to distinguish radar signal types. This distinction can be made by a mapping to a particular event table through which a radar signal detection has been made. Further, as discussed above, a radar signal can be reported as detected as soon as the number of ones in any column, or designated combination of columns, exceeds a pulse number threshold. Accordingly, the flow does not require waiting until a full event table or all such tables included are checked, but rather the detection flow can proceed until sufficient entries in designated columns in any event table have reached a minimum number of “1” values.

In this fashion, one or more event tables can be used to detect one or more distinct types of predefined signals, such as radar signals. Each entry in each table can correspond to the detecting or non-detecting of a predefined signal pulse event in a particular time slot or sampling window. Once a number of entries indicating such event detections in one or more columns have been found, a predefined signal may be indicated as detected. Further, the particular type of predefined signal detected can correspond to the event table through which the detection has been made, thus allowing for distinguishing of the predefined signal types.

A Second Exemplary Method of Detecting a Predefined Signal

An exemplary method and/or algorithm of detecting a predefined signal in a wireless network device can include the steps of: (i) changing a value of an entry in an event table with a plurality of entries when a predefined signal pulse event has been detected; (ii) repeating the changing step for a next one of the plurality of entries; and (iii) indicating that the predefined signal has been detected when one of the entry values reaches a threshold value. The predefined signal can be a radar signal and the threshold value can be zero, for example.

Referring now to FIG. 7, another exemplary event table showing an exemplary procedure of detecting a predefined signal in accordance with embodiments of the present invention is indicated by the general reference character 700. The event table may only contain one row (702), and the same number of columns as compared with the event table in FIG. 5, for example. Accordingly, similar to the exemplary event table of FIG. 5, to determine the number of columns in the event table of FIG. 7, an empirically determined event resolution (Δ) and the pulse repetition frequency (PRF) of the particular predefined signal to be detected can be used.

In FIG. 7, the initial values of event table 702 may be set to a pulse number threshold for all columns. This pulse number threshold can be related to an actual pulse number in a burst of the predefined signal to be detected. Further, different event tables may have different pulse number thresholds, which can be determined by and/or related to the number of pulses within a burst for the predefined signal to be detected by that particular event table. Also, different event tables can have different event resolution (Δ) values, for example.

Once a predefined signal pulse event occurs, a value of a corresponding entry in an event table can be changed. In the particular example shown in FIG. 7, event table 702 can have a given entry decremented by one when a predefined signal pulse event has been detected for a given time slot or sample window. This flow can proceed from one entry to the next in event table 702 in left to right fashion, for example. Once the last element of event table 702 has been reached, the next time slot or sample window can correspond to the leftmost entry in the row. The next position may then be the next column position to the right (e.g., entry 704). The procedure of decrementing corresponding entries when a predefined signal pulse event has occurred can continue until a value in any column becomes zero. Any column or entry value becoming zero can indicate that a predefined signal (e.g., a radar signal) has been detected, for example.

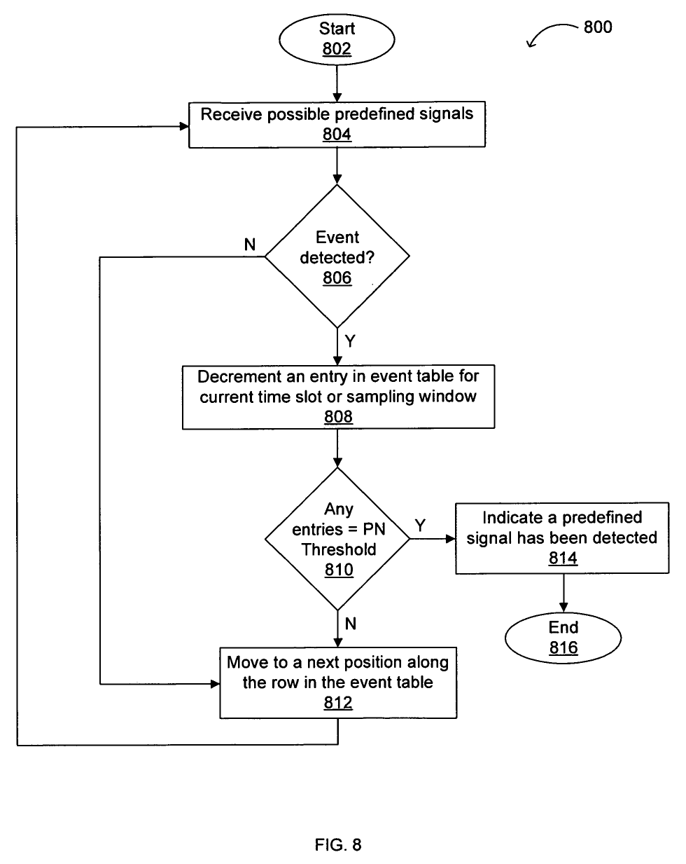

Referring now to FIG. 8, a flow diagram showing an exemplary method of detecting a predefined signal, using an event table as shown in FIG. 7, in accordance with embodiments of the present invention is indicated by the general reference character 800. The flow can begin (802) and possible predefined signals can be received (804). If a predefined signal pulse event is detected (806), a value in an entry of an event table for the current time slot or sampling window can be decremented (808). Detecting a predefined or radar signal pulse event can be performed as described above with reference to FIGS. 2 and 3, for example.

However, if no such event is detected (806) for the given time slot or sampling window, no change can be made to the corresponding entry in the event table and the position in the event table can change to a next position in the row in the event table (812) and possible predefined signals can be received (804) for the next sampling window. However, if such an event has been detected (806), an entry in the event table corresponding to the current time slot or sampling window can be decremented (808).

For each such changing or decrementing of an entry value upon the detection of a predefined signal pulse event, a check can be performed to determine if any entries are equal to a PN threshold (810). Further, values in adjacent columns may also be summed and compared against such a predetermined value. In one example, the PN threshold may be chosen to be zero. If any entries are zero (810), an indication that a predefined signal has been detected can be made (814) and the flow can complete (816). However, if no such entries hold a zero value (810), the position in the event table can change to a next position in the row in the event table (812) and possible predefined signals can be received (804) for the next sampling window.

The next position as described above (e.g., in box 812) can be from left to right along the row of an event table (e.g., 702), and may continue for some predetermined number of passes through the row or until a predefined signal has been detected. Further, a reset or initialization sequence (e.g., to return each entry value to a pulse number threshold value) can occur once some predetermined number of passes through the row have been completed, when a predefined signal has been detected, or as part of a periodic reset function, for example.

As discussed above, a different event table can be used for each predefined (e.g., radar) signal to be detected in accordance with embodiments of the present invention. Whenever a column in one such event table has a value equal to the PN threshold, an indication that the particular type of radar signal corresponding to that event table is present can be made. Further, while FCC regulations do not require a specific radar signal type report, but rather only detection of any such radar signals regardless of the signal type, the detection scheme in accordance with embodiments of the present invention can also be used to distinguish between radar signal types. This distinction can be made by mapping to a given event table through which a radar signal detection has been made.

In this fashion, one or more event tables can be used to detect one or more distinct types of predefined signals, such as radar signals. Each entry in each table can correspond to the detection or non-detection of a predefined signal pulse event in a particular time slot or sampling window. Once any entry indicating a number of such event detections (e.g., via decrementing values) in any column has been found, a predefined signal may be indicated as detected. Further, the particular type of predefined signal detected can correspond to the event table through which the detection has been made, thus allowing for distinguishing of the predefined signal types.

An Exemplary Device for Detecting a Predefined Signal

An exemplary physical layer device for detecting a predefined signal can include: (i) an event table with a plurality of entries arranged in a plurality of columns; (ii) a control circuit configured to modify one of the plurality of entries when a predefined signal pulse event is detected; and (iii) an indicator circuit configured to provide a predefined signal detection indication when one or a combination of the plurality of columns includes a predetermined value. The event table can also include a plurality of columns and the predefined signal can be a radar signal, for example.

Such a physical layer device can include processing circuitry and/or other means for detection of a radar signal as described above, for example. As such, no base band processing for determining whether a received signal is a packet or not may be required in accordance with embodiments of the present invention. Further, the physical layer device can include more than one event table, with a different event table being used for each radar signal to be detected in the device. Such event tables can be one or a combination of, the exemplary table types as shown in FIGS. 4, 5, and 7, and discussed above. Also, implementation of the tables in, or interfacing with, the physical layer device can include static random-access memory (SRAM), dynamic random-access memory (DRAM), or any other suitable type of memory element.

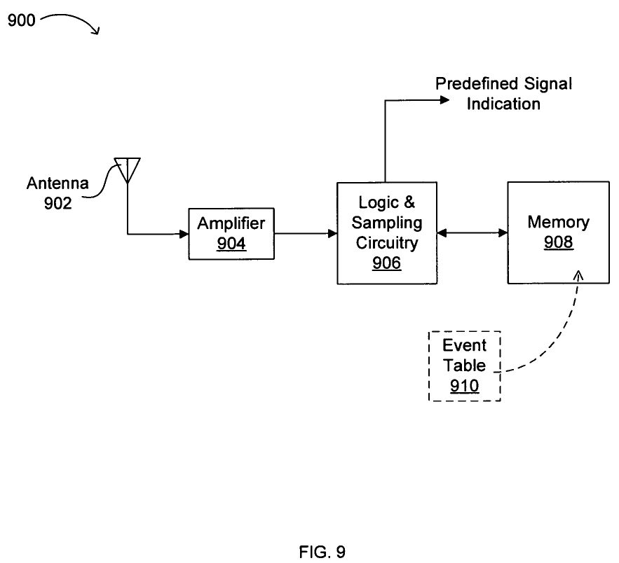

Referring now to FIG. 9, a block diagram showing an exemplary system for detecting predefined signals using event tables in accordance with embodiments of the present invention is indicated by the general reference character 900. Signals (e.g., radar signals or network traffic) can be received via antenna 902 and passed to amplifier 904. Logic and sampling circuitry 906 can receive such amplified signals from amplifier 904. One or more event tables 910 (e.g., of the exemplary table types shown in FIGS. 4, 5, and 7) can be included in memory 908. Memory 908 can include SRAM, DRAM, or any other suitable type of memory element, as discussed above.

Logic & sampling circuitry 906 can include circuits configured to implement predefined signal event detection (e.g., as in FIG. 2 and FIG. 3, and discussed above), as well as predefined signal determination (e.g., as in FIGS. 5-8, and discussed above). When the presence of a predefined signal is detected, predefined signal indication can be enabled. Further, one or more elements of system 900 (preferably, all of the elements) can be included in a physical layer device or other appropriate network device (preferably, a physical layer device).

In this fashion, one or more event tables can be used to detect one or more distinct types of predefined signals, such as radar signals, in a physical layer device. Further, the particular type of predefined signal detected can correspond to the event table through which the detection has been made, thus allowing for distinguishing of the predefined signal types.

While the above examples primarily include radar signal detection approaches, one skilled in the art will recognize that other predefined signals may also be detected in accordance with embodiments. Further, one skilled in the art will recognize that other variations of the exemplary event tables described herein may also be used in accordance with embodiments.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method of detecting a predefined signal pulse event in a wireless network device, comprising the steps of:
a) comparing a power of a received signal pulse to a predetermined power threshold of a predefined signal;
b) determining a duration of said received signal pulse when said power of said received signal pulse is greater than said predetermined power threshold; and
c) indicating an occurrence of said predefined signal pulse event when said duration of said received signal pulse is between first and second predetermined duration thresholds of said predefined signal.

2. The method of claim 1, wherein said predefined signal comprises a radar signal.

3. The method of claim 2, wherein said radar signal comprises a plurality of pulses, each of said plurality of pulses corresponding to said predefined signal pulse event.

4. The method of claim 1, wherein said first predetermined duration threshold is about an expected pulse length of said predefined signal.

5. The method of claim 3, wherein said second predetermined duration threshold is a maximum expected pulse length of said predefined signal.

6. The method of claim 2, wherein said predetermined power threshold comprises a minimum radar power level.

7. A method of detecting a predefined signal in a wireless network device, comprising the steps of:
a) inserting a first logic level into an entry in an event table comprising a plurality of entries when an occurrence of a predefined signal pulse event is detected, or inserting a second logic level into said entry when said occurrence of said predefined signal pulse event is not detected; and
b) repeating said inserting step for a next one of said plurality of entries.

8. The method of claim 7, further comprising repeating said inserting step until a logic level is entered a plurality of times in each of a plurality of columns, then indicating a presence of said predefined signal when a number of entries containing said first logic level in at least one column is greater than a threshold.

9. The method of claim 7, wherein detecting said occurrence of said predefined signal pulse event comprises:
a) comparing a power of a received signal pulse to a predetermined power threshold of said predefined signal;
b) determining a duration of said received signal pulse when said power of said received signal pulse is greater than said predetermined power threshold; and
c) indicating an occurrence of said predefined signal pulse event when said duration of said received signal pulse is between first and second predetermined duration thresholds of said predefined signal.

10. The method of claim 7, wherein said predefined signal comprises a radar signal.

11. The method of claim 7, wherein said event table has a plurality of rows and a plurality of columns.

12. The method of claim 11, wherein said event table comprises an array of N rows and M columns, where N and M are independently each an integer of at least 2.

13. The method of claim 12, wherein N is related to a number of pulses in said predefined signal.

14. The method of claim 8, wherein said number of entries containing said first logic level in at least two adjacent columns is greater than said threshold.

15. The method of claim 11, further comprising the step of forming a second event table for detecting a second predefined signal in said wireless network device.

16. The method of claim 7, wherein said repeating said inserting step for said next one of said plurality of entries comprises changing a position in said event table along one of said plurality of rows, said position corresponding to a sampling window.

17. A method of detecting a predefined signal in a wireless network device, comprising the steps of:
a) changing a value of an entry in a first event table having a plurality of entries when a first predefined signal pulse event has been detected;
b) repeating said changing step for a next one of said plurality of entries in said first event table; and
c) indicating that said predefined signal has been detected when one of said entry values reaches a threshold value.

18. The method of claim 17, wherein said detecting said first predefined signal pulse event comprises:
a) comparing a power of a received signal pulse to a predetermined power threshold of said predefined signal;
b) determining a duration of said received signal pulse when said power of said received signal pulse is greater than said predetermined power threshold; and
c) indicating an occurrence of said first predefined signal pulse event when said duration of said received signal pulse is between first and second predetermined duration thresholds of said predefined signal.

19. The method of claim 17, wherein said predefined signal comprises a radar signal.

20. The method of claim 17, wherein said first event table has a row and a plurality of columns.

21. The method of claim 17, further comprising the step of initializing said first event table by inserting a pulse number threshold into each of said plurality of entries.

22. The method of claim 21, wherein said pulse number threshold corresponds to a number of pulses in said predefined signal.

23. The method of claim 17, further comprising the steps of:
a) changing a value of an entry in a second event table having a plurality of entries when a second predefined signal pulse event has been detected; and
b) repeating said changing step for a next one of said plurality of entries in said second event table.

24. The method of claim 17, wherein changing said value of said entry in said first event table comprises decrementing said value of said entry.

25. The method of claim 24, wherein said threshold value is zero.

26. A physical layer device, comprising:
a) an event table having a plurality of entries arranged in a plurality of columns;
b) a control circuit configured to modify one of said plurality of entries when a predefined signal pulse event is detected; and
c) an indicator circuit configured to provide a predefined signal detection indication when one or a combination of said plurality of columns includes a predetermined value.

27. The physical layer device of claim 26, wherein said event table further comprises a plurality of rows.

28. The physical layer device of claim 26, wherein said control circuit is configured to insert a first logic level into said one of said plurality of entries when said predefined signal pulse event is detected or to insert a second logic level into said one of said plurality of entries when no predefined signal pulse event is detected.

29. The physical layer device of claim 26, wherein said predetermined value comprises a number of entries containing said first logic level in said one or said combination of said plurality of columns.

30. The physical layer device of claim 26, wherein said combination comprises an adjacent two of said plurality of columns.

31. The physical layer device of claim 26, wherein said control circuit is configured to decrement a value in said one of said plurality of entries when said predefined signal pulse event is detected.

32. The physical layer device of claim 31, wherein said predetermined value comprises zero.

33. The physical layer device of claim 26, further comprising a second event table for detection of a second predefined signal.

34. The physical layer device of claim 26, wherein said predefined signal comprises a radar signal.
